(19) United States
(12) Patent Application Publication
(10) Pub. No.: US 2020/0217823 A1
(43) Pub. Date: Jul. 9, 2020

(54) SEALING ASSEMBLY AND PLUG FOR NON-DESTRUCTIVE INSPECTION

(71) Applicant: BOMBARDIER INC., Dorval (CA)

(72) Inventor: Saleem SALEH, Longueuil (CA)

(21) Appl. No.: 16/825,455

(22) Filed: Mar. 20, 2020

Related U.S. Application Data
(62) Division of application No. 15/557,196, filed on Sep. 11, 2017.
(60) Provisional application No. 62/140,721, filed on Mar. 31, 2015.

(51) Int. Cl. G01N 29/32; F16L 55/128; G01N 29/28

(52) U.S. Cl. CPC G01N 29/32; G01N 2291/023; G01N 29/28; F16L 55/128

(57) ABSTRACT

A plug for inserting into an end of a tubular component to be inspected, including an air discharge unit receivable within the tubular component and having an end surface with a plurality of air outlets defined therein, a flow-directing body receivable within the component extending from the end surface of the air discharge unit with the plurality of outlets located radially outwardly of the flow-directing body, and a sealing member connected to the air discharge unit and having an extended configuration where the sealing member extends outwardly of the perimeter of the air discharge unit. A sealing assembly for a plate component to be inspected and a method of inspecting an outer surface of a component are also discussed. The plug and sealing assembly act to prevent an inspection coupling fluid from flowing on non-inspected surfaces of the component.

### CROSS-REFERENCE TO RELATED APPLICATIONS

This application claims priority from U.S. provisional application No. 62/140,721 filed Mar. 31, 2015, the entire contents of which are incorporated by reference herein.

### FIELD OF THE APPLICATION

The present application relates to inspection of components, and more particularly to non-destructive inspection performed with a coupling fluid.

### BACKGROUND OF THE ART

Some types of non-destructive inspection (NDI) such as ultrasonic inspection require that a coupling fluid, for example water, be provided on the outer surface of the component being inspected at the interface with the ultrasonic probe(s) such as to provide a path for the ultrasonic signal to pass through. However, if the coupling fluid flows to the surface opposite the surface being inspected, undesirable attenuation of the ultrasonic signal may result. False defect signatures may be obtained, which create delays in the inspection process.

Some ultrasonic probes include closed chambers where the coupling fluid is contained, or include multiple seals and systems aspirating the coupling fluid once it has circulated between the probe and surface to be inspected. However, such probes may be relatively complex to produce and/or maintain, the various systems may represent risks of failure, and/or such probe designs may not be compatible with automated inspection systems. Moreover, such probes typically do not allow inspection of the surface of the component up to its edges.

### SUMMARY OF THE APPLICATION

In one aspect, there is provided a plug for inserting into an end of a tubular component to be inspected, the plug comprising: an air discharge unit having a longitudinal axis and at least one outer surface defining a perimeter around the longitudinal axis, the perimeter receivable within the tubular component, the air discharge unit having a plurality of outlets defined therein; a flow-directing body extending from an end surface of the air discharge unit, the plurality of outlets being located radially outwardly of the flow-directing body, the flow-directing body including an inlet, the flow-directing body and air discharge unit having at least one passage defined therethrough extending from the inlet to the plurality of outlets; and a sealing member connected to the air discharge unit, the plurality of outlets located between the sealing member and the flow-directing body, the sealing member having an extended configuration where the sealing member extends outwardly of the perimeter of the at least one outer surface of the air discharge unit.

In one embodiment, a radial distance between a longitudinally extending outer surface of the flow-directing body and the longitudinal axis is at a maximum value at a first location spaced from the air discharge unit along the longitudinal axis and at a smaller value at a second location adjacent the air discharge unit, the radial distance increasing between the second and first locations.

In one embodiment, a radial distance between each of at least two longitudinally extending outer surfaces of the flow-directing body and the longitudinal axis is at a maximum value at a first location spaced from the air discharge unit along the longitudinal axis and at a smaller value at a second location adjacent the air discharge unit, the radial distance increasing between the second and first locations, the first location of one of the at least two longitudinally extending outer surfaces being spaced along the longitudinal axis from the first location of another one of the at least two longitudinally extending outer surfaces. The flow-directing body may have a cross-sectional area having a maximum value at the first location. The radial distance between the outer surface and the longitudinal axis may decrease from the first location to a third location, the first location being defined between the second and third locations. A space around the flow-directing body may define a venturi when the flow-directing body is received in a tube having a constant inner cross-section from the second to the third locations.

In one embodiment, the sealing member is inflatable and has the extended configuration when inflated, the flow-directing body and air discharge unit having an additional passage defined therethrough extending from an additional inlet of the flow-directing body to an interior of the sealing member.

In one embodiment, the sealing member is inflatable and has the extended configuration when inflated, the at least one passage of the guide body and air discharge unit communicating with an interior of the sealing member.

In one embodiment, the flow-directing body has a vacuum chamber defined therein, a vacuum chamber outlet in communication with the vacuum chamber, and at least one vacuum chamber inlet in communication with the vacuum chamber, the at least one vacuum chamber inlet located adjacent an outer surface of the flow-directing body and facing the plurality of outlets of the air discharge unit to receive a flow exiting from the plurality of outlets and traveling along the outer surface of the flow-directing body.

In one embodiment, the perimeter of the air discharge unit has a triangular or trapezoidal shape.

In another aspect, there is provided a plug assembly comprising the plug and a guide having outer surfaces complementary to that of the tubular component to be inspected such as to define an extension of the tubular component when engaged thereto, the flow-directing body partially received in the guide, the air discharge unit, sealing member and a portion of the flow-directing body extending outside of the guide.

In another aspect, there is provided a sealing assembly comprising a plurality of plug assemblies; a base, each guide detachably engageable to the base with the plurality of plug assemblies spaced apart from one another, each plug protruding from the base; a manifold in communication with the inlet of each plug; and a source of pressurized air in communication with the manifold.

In another aspect, there is provided a plug assembly for engaging an end of a tubular component to be inspected, the assembly comprising: a guide having interconnected walls defining outer surfaces complementary to that of the tubular component to be inspected such as to define an extension of the tubular component when a first end of the guide is adjacent thereto, at least one of the interconnected walls having a plurality of openings defined therethrough; a flow-directing body having a longitudinal axis, the flow-directing body having a first end received in the guide and sealingly engaged to the interconnected walls with the plurality of openings located between the first end of the flow-directing body and the first end of the guide, the flow-directing body extending out of the first end of the guide, the flow-directing body having an outer surface extending a radial distance from the longitudinal axis, the radial distance increasing from a location proximal the plurality of openings to a location proximal the first end of the guide, the radial distance decreasing from the location proximal the first end of the guide to a location proximal a second end of the flow-directing body.

In a particular embodiment, the plug assembly further comprises fins extending outwardly from the outer surface of the flow-directing body in a portion of the flow-directing body located outside of the guide, the fins being receivable in a perimeter corresponding to that defined by the inner surfaces of the interconnected walls of the guide.

In another aspect, there is provided a method of inspecting an outer surface of a component, the method comprising: juxtaposing an edge of a guide to an edge of the component and aligning an outer surface of the guide with the outer surface of the component, the component having an inner surface opposite the outer surface; creating a flow of air along the inner surface of the component toward the edge of the component, across a gap between the edge of the component and the edge of the guide, and in the guide away from the inner surface of the component; flowing a coupling fluid onto the outer surface of the component; and with the flow of air, directing at least a portion of the coupling fluid from the outer surface of the component into the gap between the edge of the component and the edge of the guide and in the guide away from the inner surface of the component.

In a particular embodiment, the component is a tubular component and juxtaposing the edges of the guide and component includes juxtaposing open ends of the guide and tubular component. Creating the flow of air may include: inserting a plug partially into the tubular component and partially into the guide, including sealingly engaging the plug with the inner surface of the component; flowing air out of the plug from inside the component toward the guide, between an outer surface of a flow-directing body of the plug and the inner surface of the component, across the gap between the edge of the component and the edge of the guide, and between the outer surface of the flow-directing body and an inner surface of the guide. The method may further include creating a venturi between the outer surface of the flow-directing body and the inner surfaces of the component and the guide in proximity of the gap between the edges of the guide and component.

In a particular embodiment, the guide and component are made of different materials.

In a particular embodiment, the component is a plate component, the edge of the plate component being defined along a perimeter of a hole through the plate component, the guide at least partially received through the hole, the edge of the guide being defined along a perimeter of the guide. The guide may be part of a body including a base, and creating the flow of air may include: inserting the guide in the hole of the plate component, and sealingly engaging an outer surface of the base with the inner surface of the component away from the guide; flowing air between the outer surface of the base and the inner surface of the component toward the guide, across the gap between the edges of the component and of the guide, and in a drain passage of the body, the drain passage extending away from the inner surface of the component. An additional flow of air may be created through the body and in a part of the drain passage offset from the gap between the edges of the component and of the guide, the flow of air and additional flow of air flowing along a same direction.

In a further aspect, there is provided a sealing assembly for a plate component having an outer surface to be inspected and an opposed inner surface, the plate component having a hole defined therethrough, the assembly comprising: a body defining a base and a guide, the base having an outer surface complementary to the inner surface of the plate component, the guide extending outwardly from the outer surface of the base and sized to be received in the hole of the plate component with an annular gap being defined around the guide; a sealing member extending outwardly from the outer surface of the base, the sealing member spaced from the guide; the body having a first inlet located away from the outer surface of the base, a first outlet opening into the outer surface of the base and located between the sealing member and the guide, and a first passage defined through the body providing communication between the first inlet and the first outlet; and the body having a second inlet in communication with the annular gap around the guide, a second outlet located away from the outer surface of the base, and a second passage defined through the body providing communication between the second inlet and the second outlet.

In a particular embodiment, at least a first portion of the second passage defined from the second inlet is oriented to define a flow direction toward a longitudinal axis of the guide.

In a particular embodiment, the guide and base are separate elements, the second passage being defined through the guide.

In a particular embodiment, the body is monolithic.

In a particular embodiment, the body further comprises a third passage defined therethrough having an outlet in communication with the second passage intermediate the inlet and outlet ends thereof, the third passage having an orientation similar to that of the second passage immediately upstream of the outlet of the third passage.

In a particular embodiment, the outer surface of the base is curved.

In a particular embodiment, the assembly further comprises a source of pressurized air in communication with the first passage.

In a particular embodiment, the sealing member is a first sealing member, the assembly further comprising a second sealing member extending outwardly from the outer surface of the base with the first sealing member located between the second sealing member and the guide, the body further having a vacuum passage defined therethrough in communication with a vacuum inlet opening into the outer surface of the base between the first and second sealing members, and a vacuum source in communication with the vacuum passage.

### BRIEF DESCRIPTION OF DRAWINGS

For a better understanding of the present invention, as well as other aspects and further features thereof, reference is made to the following description which is to be used in conjunction with the accompanying drawings, where:

FIG. 1 is a schematic tridimensional view of an aircraft according to a particular embodiment;

FIG. 2 is a schematic tridimensional view of a part of a sealing assembly for engagement to structural components of the aircraft of FIG. 1 for inspection thereof, according to a particular embodiment;

FIG. 3 is a schematic tridimensional exploded view of some of the elements of the sealing assembly of FIG. 2;

FIG. 4 is a schematic tridimensional view of a plug assembly which may be part of the sealing assembly of FIG. 2, shown engaged in a stringer, with the stringer and the guide of the plug assembly depicted as transparent for improved clarity;

FIG. 5 is a schematic cross-sectional view of a plug assembly and stringer similar to that of FIG. 4, but with a flow-directing body having a different configuration;

FIG. 6 is a schematic enlarged cross-sectional view of portion A of FIG. 4 and FIG. 5, showing flows of air and coupling fluid;

FIG. 7 is a schematic cross-sectional view of a plug in accordance with an alternate embodiment;

FIG. 8 is a schematic cross-sectional view of a plug in accordance with another alternate embodiment;

FIG. 9 is a schematic side view of a plug assembly in accordance with yet another alternate embodiment;

FIG. 10 is a schematic tridimensional view of a bulkhead of an aircraft such as shown in FIG. 1;

FIG. 11 is a schematic tridimensional view of a guide of a sealing assembly which may be used with the bulkhead of FIG. 10, in accordance with a particular embodiment;

FIG. 12 is a schematic cross-sectional view of a part of a sealing assembly including the guide of FIG. 11; and

FIG. 13 is a schematic cross-sectional view of a part of a sealing assembly which may be used with the bulkhead of FIG. 10, in accordance with another particular embodiment.

In the drawings, embodiments of the invention are illustrated by way of example. It is to be expressly understood that the description and drawings are only for purposes of illustration and as an aid to understanding. They are not intended to be a definition of the limits of the invention.

### DESCRIPTION OF PREFERRED EMBODIMENTS

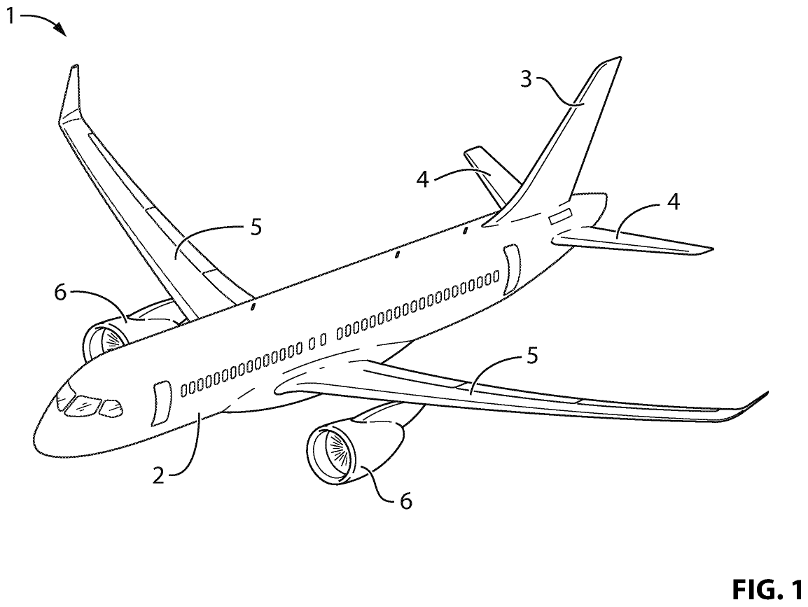

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft.

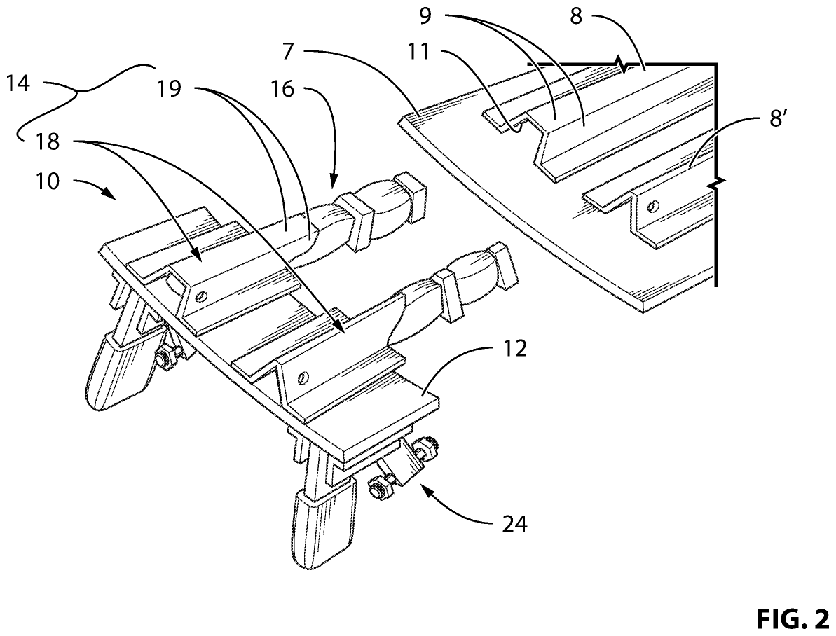

Referring to FIG. 2, structural components such as for example portions of the fuselage 2, bulkheads and/or wings 5 of the aircraft 1 may have a configuration including a skin 7 and a plurality of stiffening members 8, 8′ (hereinafter referred to as stringers 8, 8′) attached to the skin 7 to provide reinforcement thereto. In a particular embodiment, each stringer 8, 8′ connected to the skin 7 defines a tubular component with a closed perimeter having for example a triangular or delta (Δ) shape (for stringers 8′ having an inverted V shape formed by two walls connected at an apex and extending from a base) or a trapezoidal shape (for stringers 8 having an omega or top-hat shape formed by two angled walls extending from a base and interconnected by a top wall). Although both shapes of stringers 8, 8′ are shown as part of a same structural assembly, it is understood that in another embodiment all the stringers of a same structural assembly may have the same configuration.

In a particular embodiment, the stringers 8, 8′ and skin 7 are made of composite materials and co-cured, and are inspected after curing, for example to ensure that no delamination is present. Other manufacturing processes may also require similar inspection. In a particular embodiment, the inspection process is to performed with an automated ultrasound machine having at least one, and preferably a plurality of, probe(s) traveling on the stringers 8, 8′ and emitting ultrasonic waves which are received and analyzed to evaluate if defects are present. The ultrasound machine applies a coupling fluid, preferably water, on the outer surface of the stringers 8, 8′ to form an interface between the probe(s) and outer surface for the ultrasonic waves to travel therethrough.

It is understood that the terms “outer” and “inner” and similar terms as used herein, for example with respect to component surfaces, refer to a disposition relative to the probe(s) of the inspection machine (the probe(s) being considered to be on the outer side of the inspected component) and are not intended to be indicative of the position of the surface when the component is installed in the aircraft 1.

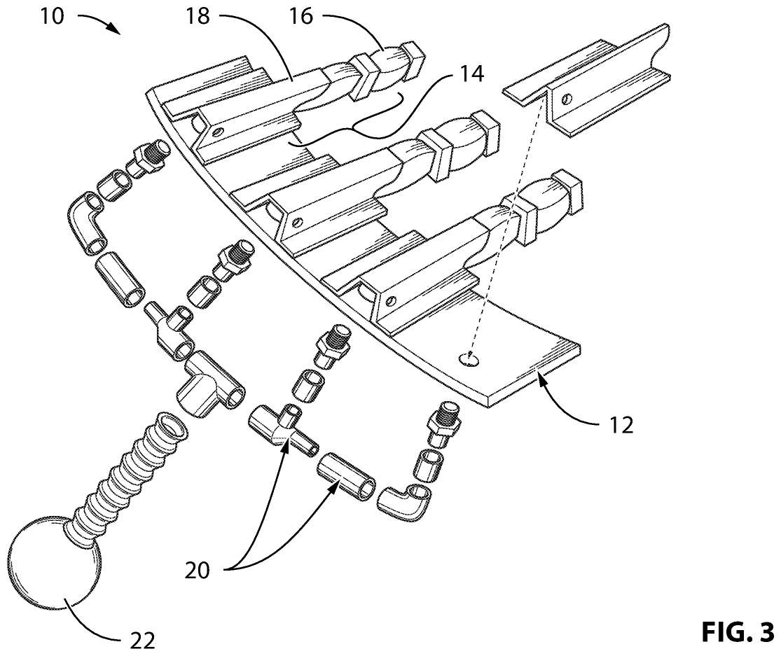

Referring to FIGS. 2-3, a sealing assembly is generally shown, which uses air supplied from within the stringer 8, 8′ to reduce the risk of, or prevent, ingress of the coupling fluid into the interior of the stringers 8, 8′ and along the inner surface 11 thereof, for example to ensure that the ultrasonic signal is representative of the state of the stringer 8, 8′ being inspected. The sealing assembly 10 generally includes a base 12, a plurality of plug assemblies 14 each including a plug 16 partially received in a guide 18 with the guides 18 detachably and securely engageable to the base 12 and the plugs 16 protruding from the base 12, a manifold 20 (FIG. 3) connected to each plug 16, and a source of pressurized air 22 (FIG. 3, e.g. compressor) providing pressurized air to the manifold 20. The sealing assembly 10 preferably includes an attachment system 24 (FIG. 2) to secure it to the structural component being inspected, in the embodiment shown including a plurality of clamps connected to the base 12 and engageable to the skin 7 between or under the stringers 8, 8′ being inspected. Other configurations are also possible.

Referring to FIG. 2, each guide 18 has walls defining outer surfaces 19 complementary to the outer surfaces 9 of the stringer 8, 8′ to be inspected such as to define an extension of the stringer 8, 8′ when engaged thereto, with corresponding outer surfaces 9, 19 of the stringer and guide being aligned with one another. Accordingly, the probe(s) of the inspection machine can slide continuously across the gap between the edges of the stringer 8, 8′ and the guide 18, allowing the ends of the stringer 8, 8′ to be inspected even if the inspection machine includes multiple offset probes.

The sealing assembly 10 allows for multiple plug assemblies 14 to be simultaneously engaged to their respective stringers 8, 8′, which in a particular embodiment allows for a reduction of the set up time. It is understood that the plug assemblies 14 can alternately be used individually, i.e. separately from one another.

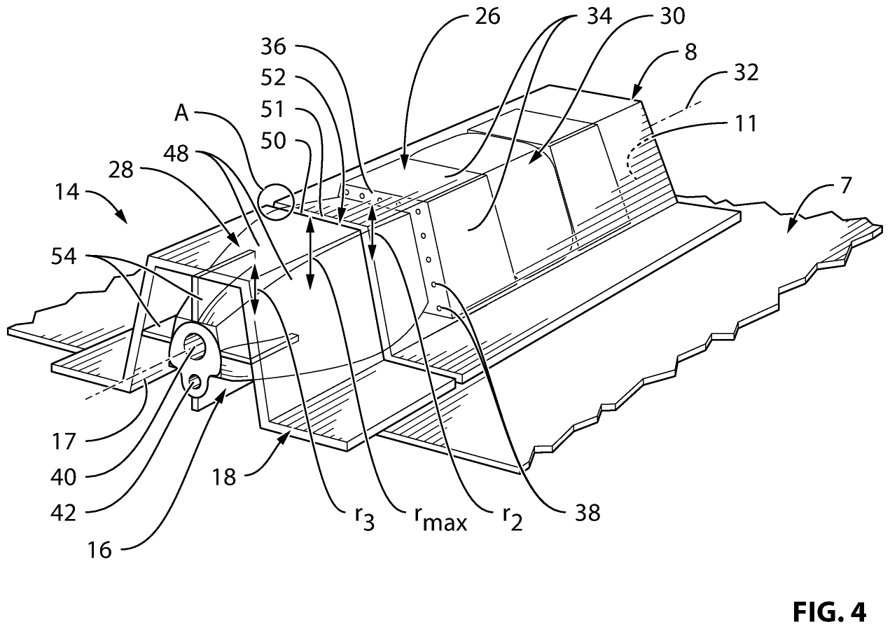

Referring to FIG. 4, a plug assembly 14 according to a particular embodiment is shown. The plug assembly 14 generally includes the plug 16 and the guide 18. The plug 16 is configured to be inserted into the open end of the stringer 8. The plug 16 generally includes an air discharge unit 26, a flow-directing body 28 and a sealing member 30. The flow-directing body 28 is partially received in the guide 18, and the air discharge unit 26, sealing member 30 and a portion of the flow-directing body 28 extend outside of the guide 18 and are designed to be received within the stringer 8. The guide 18 and stringer 8 are depicted as transparent in the figure for increased clarity.

The air discharge unit 26 has a central longitudinal axis 32, which in a particular embodiment is defined in a plane of symmetry of the air discharge unit 26. The air discharge unit 26 has a plurality of outer surfaces 34 defining a perimeter around the longitudinal axis 32. The perimeter corresponds to that of the interior of the stringer 8, and is configured to be receivable therein, preferably in a snug manner while still being easily insertable therein. In the embodiment of FIG. 4, the air discharge unit 26 includes four outer surfaces 34 defining a trapezoidal perimeter, corresponding to the trapezoidal shape of the tubular component formed by the inner surfaces 11 of the skin 7 and omega stringer 8 attached thereto, minus a sufficient clearance to be able to insert the air discharge unit 26 therein. It is understood that the number of outer surfaces 34 and shape of the perimeter defined by the outer surfaces 34 will vary according to the shape of the tubular component being inspected, and accordingly the perimeter of the air discharge unit may be defined by a single outer surface (e.g. cylindrical component), two outer surfaces (e.g. semi-cylindrical component), three outer surfaces (e.g. triangular component such as the inverted V stringer 8′ attached to a skin 7 shown in FIG. 2), and more than four outer surfaces. The air discharge unit 26 also includes an end surface 36 substantially transverse (including, but not limited to, perpendicular) to the longitudinal axis 32. In the embodiment shown, the end surface 36 is perpendicular to the longitudinal axis 32. The air discharge unit 26 includes a plurality of air outlets 38 defined in the end surface 36.

The sealing member 30 is engaged to the air discharge unit 26 spaced from the end surface 36. The sealing member 30 is compressible, and in its extended configuration extends outwardly of the perimeter of the air discharge unit 26 but compressible by the inner surfaces 11 of the stringer 8 and skin 7 for a sealing engagement therewith. In the embodiment shown, the sealing member 30 is inflatable and has the extended configuration when inflated. The inflatable sealing member 30 may be provided in the form of a tubular chamber surrounding a recessed portion of the air discharge unit 26. Other configurations are also possible. Alternately, the sealing member 30 may be non-inflatable and be made of compressible sealing material, such as for example a suitable type of foam.

The flow-directing body 28 is receivable within a perimeter corresponding to that of the air discharge unit 26, such as to be partially receivable into the stringer 8 with the air discharge unit 26. The flow-directing body 28 extends from the end surface 36 of the air discharge unit 26 with the plurality of air outlets 38 located radially outwardly of the flow-directing body 28. In the embodiment shown, the air outlets 38 are distributed circumferentially around the flow-directing body 28.

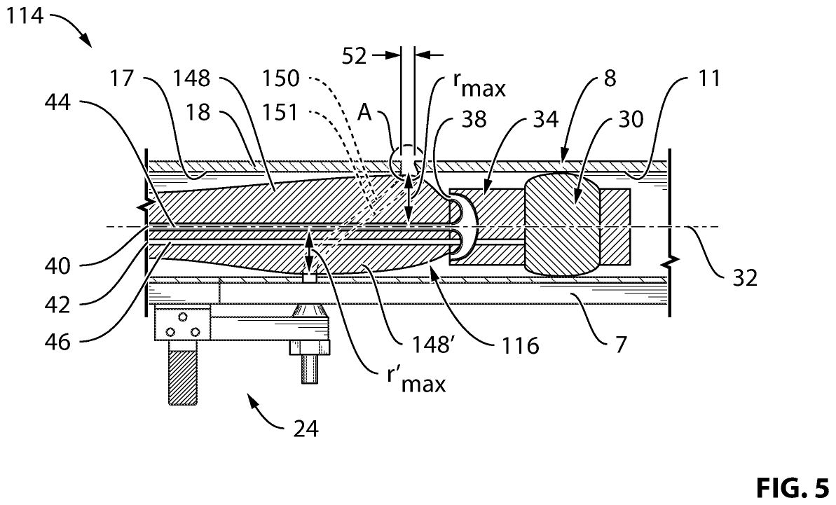

In the embodiment shown, the flow-directing body 28 includes first and second inlets 40, 42 at the end extending away from the air discharge unit 26. The flow-directing body 28 and air discharge unit 26 may have first and second air passages 44, 46 defined therethrough (not visible in FIG. 4, but similar to that shown for the embodiment of FIG. 5), each extending from one of the inlets 40, 42. The first air passage 44 communicates with the air outlets 38 of the air discharge unit 26, for example by including a plenum defined in the air discharge unit 26 with which all of the outlets 38 communicate. The second air passage 46 communicates with an interior of the inflatable sealing member 30, such as to provide the pressurized air inflating it to its extended state. Other configurations are also possible. For example, if the sealing member 30 is not inflatable, a single inlet and air passage may be provided.

Still referring to FIG. 4, in a particular embodiment, the flow-directing body 28 includes four longitudinally extending outer surfaces 48, i.e. a same number of outer surfaces 48 as the air discharge unit 26. Each outer surface 48 of the flow-directing body 28 has a variable radial distance with respect to the longitudinal axis 32 along its length. The radial distance between the outer surface 48 and the longitudinal axis 32 is at a maximum value rₘₐₓ at a first location spaced from the air discharge unit 26 and at a smaller value r₂ at a second location adjacent the air discharge unit 26, with the radial distance increasing between the second and first locations. Such a configuration helps direct the flow of air out of the air outlets 38 of the air discharge unit 26, as will be further detailed below. The maximum radial distance rₘₐₓ between the outer surface 48 and the longitudinal axis 32 is preferably defined such as to be in alignment with or in proximity of the edge 50 of the guide 18 in which the plug 16 is partially received.

In the embodiment of FIG. 4, the flow-directing body 28 has the same plane of symmetry as the air discharge unit 26, and the radial distance between each outer surface 48 and the longitudinal axis 32 varies similarly around the perimeter defined by the outer surfaces 48. The points of maximum radial distance rₘₐₓ around the perimeter of the outer surfaces 48 are aligned, i.e. at a same location along the longitudinal axis 32, and accordingly the flow-directing body 28 has a maximal cross-sectional area at that location. Such a configuration is preferably used with a guide having an edge 50 defined perpendicularly to the longitudinal axis 32, as shown.

The radial distance between each outer surface 48 and the longitudinal axis 32 decreases from the maximum location rₘₐₓ toward the end of the flow-directing body 28 extending away from the air discharge unit 26 (see e.g. location r₃). Accordingly, the flow-directing body 28 has a bullet shape or substantial bullet shape, and in use the largest cross-sectional area is located at or near the gap between the adjacent stringer 8 and guide 18.

In a particular embodiment, the flow-directing body 28 and/or air discharge unit 26 is/are manufactured using an additive manufacturing process. Other manufacturing methods may alternately be used. Suitable materials for the flow directing body 28, air discharge unit 26 and guide 18 include, but are not limited to, carbon fiber materials, suitable plastics, and metal e.g. aluminum.

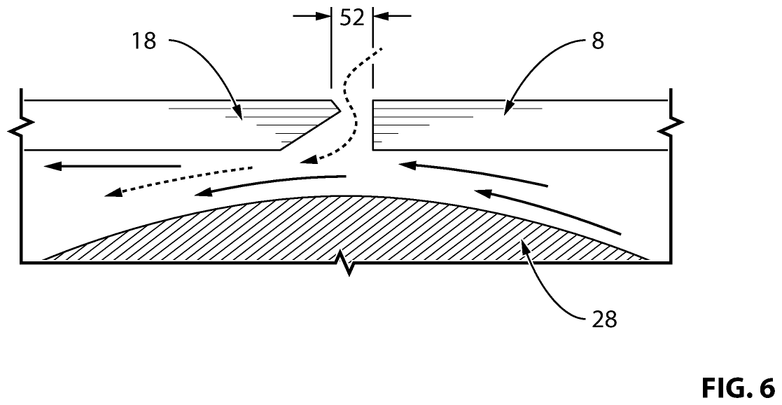

In use, air supplied in the inlet 40 of the flow-directing body 28 flows through the first air passage 44 (FIG. 5) and of the outlets 38 of the end surface 36 of the air discharge unit 26. The air flows between the flow-directing body 28 and the inner surface 11, 17 of the stringer 8 and then of the guide 18. The flow of air toward the guide 18 directs any fluid entering the gap 52 between the adjacent edges 50, 51 of the guide 18 and stringer 8 toward the guide 18 and away from the stringer 8. As can be seen from FIG. 6, the adjacent stringer 8 and guide 18 form a tubular component having a constant inner cross-section, and the space around the flow-directing body 28 within the stringer 8 and the guide 18 defines a venturi, with the gap 52 between the stringer 8 and guide 18 being located at or in proximity of the smallest cross-section of the venturi. Any fluid in proximity of the gap 52 is thus “pulled” through the gap 52 by the air flowing in the space between the flow-directing body 28 and the inner surfaces 11, 17 of the stringer 8 and guide 18, and directed along the direction of the air flow, the air flow being illustrated in the Figure by full lines and the coupling fluid flow by dotted lines. In another embodiment, the venturi configuration may be omitted.

Referring back to FIG. 4, in the embodiment shown, the plug 16 further includes fins 54 extending outwardly from the outer surfaces 48 of the flow-directing body 28 in the portion of the flow-directing body 28 located outside of the guide 18. The fins 54 are receivable in a perimeter corresponding to that defined by the inner surfaces 17 of the guide walls and are engaged thereto. The fins 54 may be airfoil shaped to help direct the air flow coming from the stringer 8 along the outer surfaces 48 of the flow directing body 28, and/or minimize airflow restriction, and/or may be configured to help maintain the flow-directing body within the guide 18, for example through a friction fit. Alternately, the fins may be omitted or replaced by any other type of support maintaining flow-directing body 18 within the guide.

Referring to FIG. 5, a plug assembly 114 with a plug 116 according to another embodiment is shown, with elements similar to those of the plug assembly 14 of FIG. 4 being identified by the same reference numerals. In the embodiment of FIG. 5, the edges 150, 151 of the guide end and of the stringer end are angled with respect to the plane perpendicular to the longitudinal axis 32. The flow-directing body 128 also has the same plane of symmetry as the air discharge unit 26, but the location of the maximal distance rₘₐₓ between the outer surface 148 of the flow-directing body 128 and the longitudinal axis 32 is different for some of the outer surfaces 148, i.e. the locations of the maximal distance rₘₐₓ of different outer surfaces 148 are located at a different positions along the longitudinal axis 32. In the embodiment shown, the maximal distance rₘₐₓ for the top outer surface 148 is defined closer to the air discharge unit 26 than the maximal distance rₘₐₓ for the bottom outer surface 148′. The flow-directing body 128 is thus shaped such that the points where the outer surfaces 148, 148′ are closest to the inner surfaces 17, 11 of the guide 18 and stringers 8 are defined along or in proximity of the gap 52 between the ends of the stringer and guide, and accordingly follow the angled profile of the gap 52.

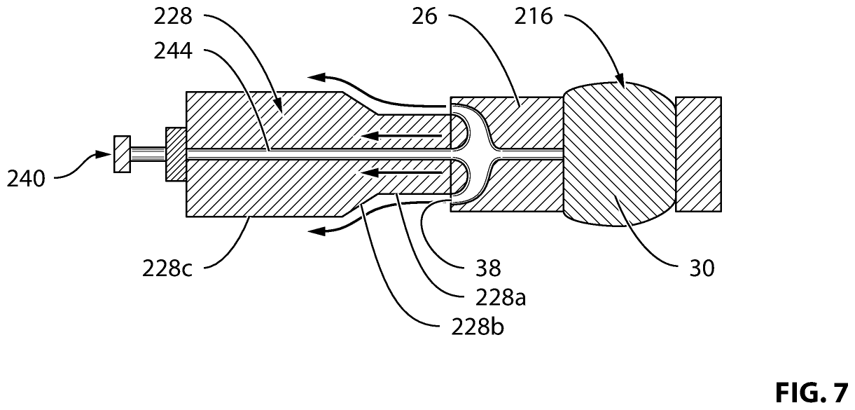

Referring to FIG. 7, a plug 216 according to another embodiment is shown. In this embodiment, the sealing member 30 is inflatable but a single inlet 240 and air passage 244 are provided to simultaneously provide air to inflate the sealing member 30 and to circulate out of the plurality of outlets 38. The flow-directing body 228 has a first portion 228a of constant cross-sectional area adjacent the air discharge unit 26, a second portion 228b extending from the first portion 228a and having a cross-section increasing from that of the first portion 228a, and a third portion 228c extending from the second portion 228b and having a constant cross-section corresponding to the maximum cross-section of the second portion 228b. The third portion 228c may define a perimeter similar to that of the air discharge unit 26.

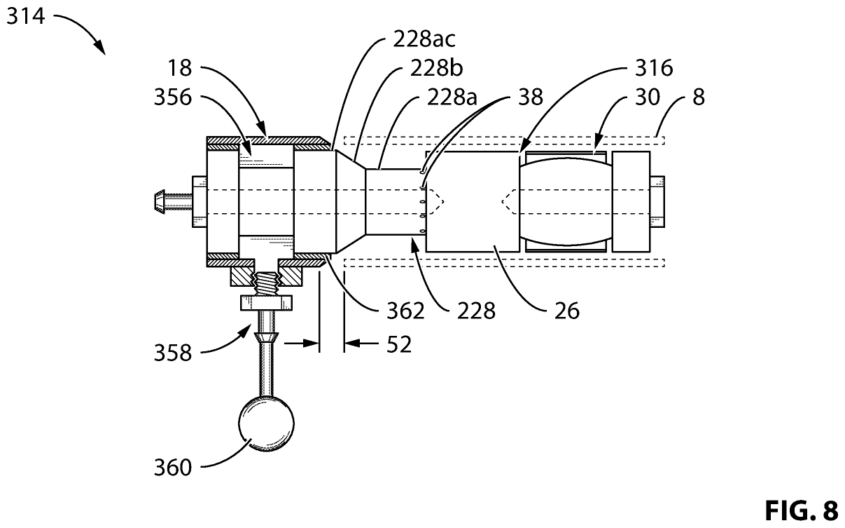

Referring to FIG. 8, a plug assembly 314 according to another embodiment is shown. In this embodiment, the plug 316 has a flow-directing body 228 with a vacuum chamber 356 defined therein. A vacuum chamber outlet 358 is defined through the flow-directing body 228 in communication with the vacuum chamber 356, for connection with a vacuum source 360 (e.g., pump). At least one vacuum chamber inlet 362 is defined through the flow-directing body 228 in communication with the vacuum chamber 356, adjacent the outer surfaces of the flow-directing body 228 and facing the plurality of air outlets 38 of the air discharge unit 26. In the embodiment shown, the vacuum chamber inlet 362 is a multi-port inlet extending around the circumference of the flow-directing body 228. Accordingly, the vacuum in the vacuum chamber 356 pulls the air flow exiting from the plurality of air outlets 38 and traveling along the outer surfaces of the flow-directing body 228, as well as any fluid penetrating through the gap 52 between the guide 18 and stringer 8 to the vacuum inlet(s) 362. The air and fluid are evacuated through the vacuum chamber outlet 358.

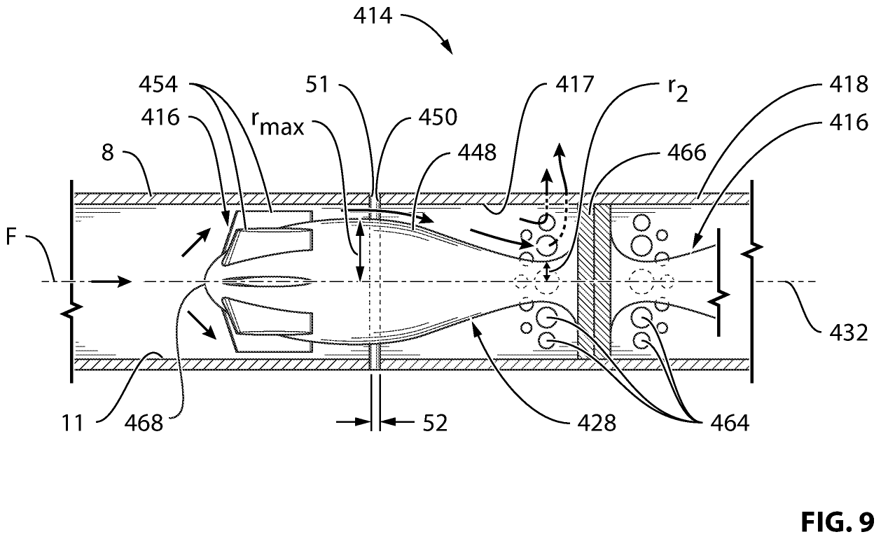

Referring to FIG. 9, a plug assembly 414 according to another embodiment is shown. This plug assembly 414 does not include an air discharge unit, and is designed to be used for example in conjunction with an air discharge unit provided at the opposed end of the stringer 8. In a particular embodiment, any of the previously described plugs 16, 116, 216, 316 may include one or more outlets on the air discharge unit 26 directing a flow of air on the side of the sealing member 30 opposite the flow-directing body, and be inserted in one end of the stringer 8 to produce an air flow F inside the stringer 8, while the plug assembly 414 of FIG. 9 is engaged with the opposed end of the stringer 8. Other configurations of pressurized air sources could alternately be provided in the stringer 8 spaced from the plug assembly 414 to produce the air flow F inside the stringer 8 toward the plug assembly 414.

The guide 418 of the plug assembly 414 has a plurality of openings 464 defined through one or more of its walls, spaced apart from the edge 450 configured to be adjacent the edge 51 of the stringer 8. The flow-directing body 428 of the plug 416 has a first end 466 received in the guide 418 and sealingly engaged to the interconnected walls of the guide 418, and extends out of the guide 418. The openings 464 through the guide wall(s) are located between the first end 466 of the flow directing body 428 and the guide edge 450 configured to be adjacent the edge 51 of the stringer 8. The radial distance between a longitudinal axis 432 of the plug 416 and the outer surfaces 448 of the flow-directing body 428 increases from a location r₂ proximal the plurality of openings 464 to a maximum rₘₐₓ proximal the edge 450 of the guide 418, i.e. the outer surfaces 448 of the flow-directing body 428 extends closer to the inner surfaces 417 of the guide walls proximal the edge 450 than at the openings 464. The cross-sectional area of the flow-directing body 428 then decreases from the edge 450 of the guide 418 to the end 468 of the flow-directing body 428 located outside of the guide 418. Accordingly, the flow-directing body 428 has a bullet shape or substantial bullet shape, with in use the largest cross-sectional area being located at or near the gap 52 between the edges 450, 51 of the guide 418 and stringer 8.

The air flow F coming at the end 468 of the flow-directing body 428 located inside the stringer 8 thus flows around the flow-directing body 428, into the guide 418 and out of the openings 464, “pulling” any fluid located at the gap 52 between the stringer 8 and guide 418 to follow the air flow toward the guide 418.

In the embodiment shown, the plug 416 further includes fins 454 extending outwardly from the outer surfaces 448 of the flow-directing body 428 in the portion of the flow-directing body 428 located outside of the guide 418. The fins 454 are receivable in a perimeter corresponding to that defined by the inner surfaces 417 of the guide walls, and engageable to the inner surface 11 of the stringer walls when in use. The fins 454 may be airfoil shaped to help direct the air flow along the outer surfaces 448 of the flow directing body 428 toward the guide 418 and/or minimize airflow restriction and/or may be configured to help maintain the flow-directing body 428 within the stringer 8, for example through a friction fit.

In a particular embodiment, the plug assembly 414 includes two similar plugs 416 received in a same guide, disposed with the ends 466 sealingly engaged to the guide walls adjacent one another and extending in opposite directions, such that each extends out of a respective end of the guide 418. The guide walls have two sets of openings 464 defined therein, one for each flow-plug 416. Such a plug assembly may be used for example to engage the ends of aligned stringers spaced apart from one another, particularly when the space between the stringers is too limited to use one of the previously describes plugs 16, 116, 216, 316 including the air discharge unit 26.

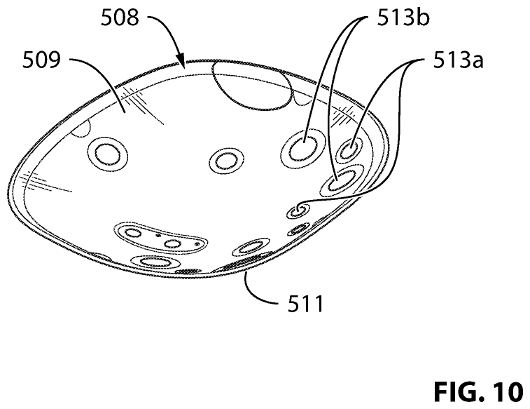

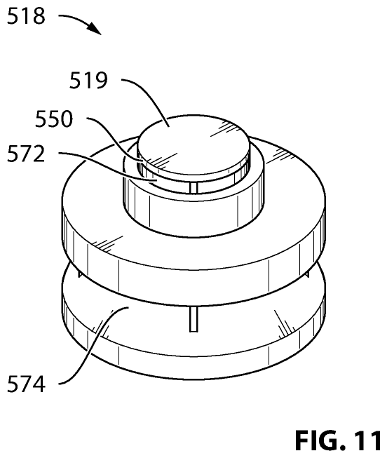

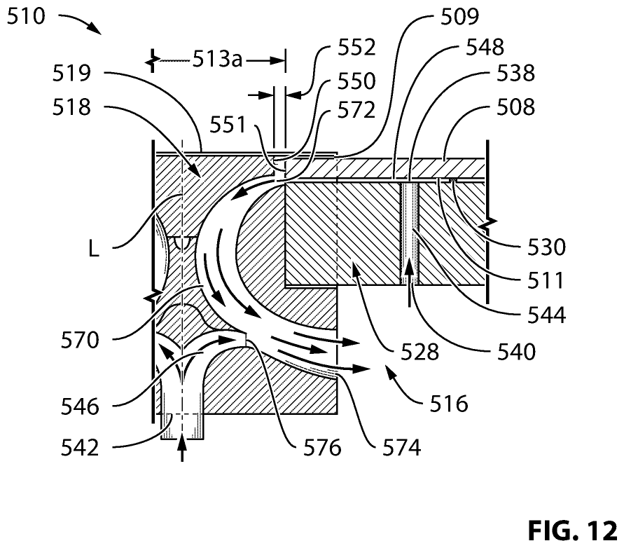

In another embodiment and with reference to FIG. 10, the outer surface 509 of a plate component 508 having a plurality of holes 513a, 513b defined therethrough, such as for example an aircraft bulkhead, is also inspected with the help of a coupling fluid. Referring to FIGS. 11-12, a sealing assembly 510 for engagement with a plate component 508 such as the bulkhead of FIG. 10 is shown. The sealing assembly 510 may be used to reduce the risk of or prevent ingress of the coupling fluid along the inner surface 511 of the component, particularly through one of the holes 513a, 513b. The sealing assembly 510 generally includes a body 516 having a base 528 and a guide 518. In the embodiment shown, the guide 518 and base 528 are separate elements which are interconnected or otherwise retained in an adjacent manner.

The base 528 has an outer surface 548 complementary to the inner surface 511 of the plate component 508, such as to be in close engagement therewith. The shape of the outer surface 548 of the base 528 is thus determined by the shape of the inner surface 511 of the plate component 508. In a particular embodiment, the plate component 508 is a curved bulkhead, and the outer surface 548 of the base 528 is correspondingly curved. Other shapes are of course possible.

The guide 518 extends outwardly from the outer surface 548 of the base 528 and is sized to be received in the hole 513a of the plate component 508 with an annular gap 552 remaining between the edge 550 of the guide 518 and the edge 551 of the hole 513a. In use, the outer surface 519 of the guide 519 is aligned with the outer surface 509 of the plate component 508, and accordingly, the probe(s) of the inspection machine can slide continuously across the transition between the plate component 508 and guide 518, allowing the plate component 508 to be inspected up to the edge of the hole 513a.

The assembly 510 further includes a sealing member 530, for example made of compressible material, extending outwardly from the outer surface 548 of the base 528 and spaced from the guide 518. The base 528 includes an inlet 540 and has an air passage 544 defined therethrough communicating with the inlet 540, and with an outlet 538 in the outer surface 548 of the base 528. The outlet 538 is located between the sealing member 530 and the guide 518. The sealing member 530 forces the air coming out of the outlet 538 to flow toward the guide 518.

The guide 518 has a drain passage 570 defined therethrough extending from an inlet end 572 in communication with the annular gap 552 around the guide 518 to an outlet end 574 located away from the outer surface 548 of the base 528. The first portion of the drain passage 570 defined from the inlet end 572 is oriented to define a flow direction toward a longitudinal axis L of the guide 518. The drain passage 570 is curved and the outlet end 574 is defined below the base 528.

The guide 518 also includes an additional inlet 542 and has an additional air passage 546 defined therethrough in communication with the additional inlet 542. The additional air passage 546 has an outlet 576 in communication with the drain passage 570 intermediate its inlet and outlet ends 572, 574. The portion of additional air passage 546 immediately upstream of its outlet 576 has an orientation similar to that of the drain passage 570 such that the air flowing out of the additional air passage 546 is directed along the same direction as the flow within the drain passage 570. The air flowing from the additional air passage 546 into the drain passage 570 creates a venturi effect helping to “pull” the fluid in the upstream portion of the drain passage 570 toward the outlet end 574 of the drain passage 570.

The two inlets 540, 542 may be engaged to a common source or pressurized air, or to different sources of pressurized air (not shown).

In use, air flows through the air passage 544 of the base 528, between the outer surface 548 of the base 528 and the inner surface 511 of the plate component 508, into the annular gap 552 between the plate component 508 and guide 518, and into the drain passage 570. The air flow directs and “pulls” any fluid located in proximity of the annular gap 552 into the annular gap 552 and through the drain passage 570, away from the inner surface 511 of the plate component 508. The air intake of the additional air passage 546 at the inlet 542 creates a vacuum at the outlet end 574 of the drain passage 570 which further “pulls” the fluid from the inlet 540 and annular gap 552 to the outlet end 574 of the drain passage 570.

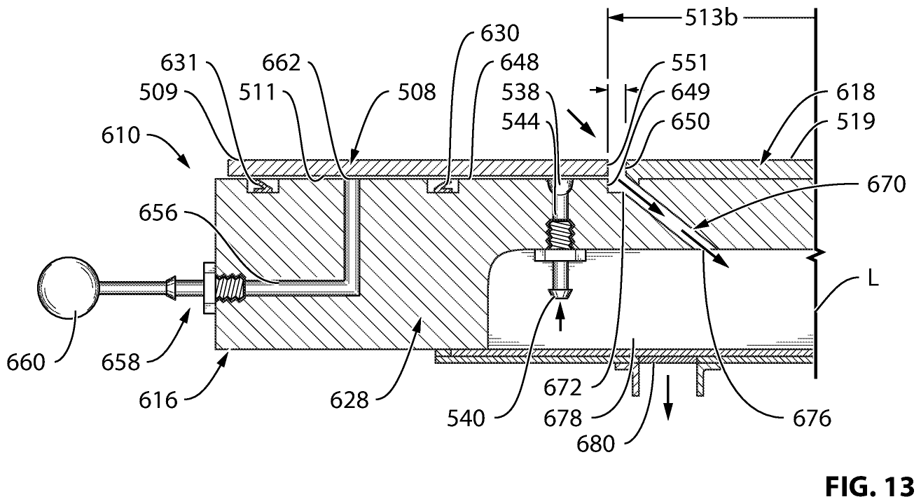

Referring to FIG. 13, a sealing assembly 610 according to another particular embodiment is shown, also for use with a plate component 508 such as the bulkhead of FIG. 10. In this embodiment, the guide 618 and base 628 are part of a monolithic body 616. The guide 618 is inserted in a hole 513b of the plate component 508, with an annular gap 552 remaining around the edge 650 of the guide 618 and the edge 551 of the hole 513b. The outer surface 648 of the base 628 defines an edge 649 extending around the guide 618 and spaced therefrom by the annular gap 552 around the guide 618.

The sealing member 630 is a seal which is part of a retention mechanism allowing the base 628 to be retained against the inner surface 511 of the plate component 508. The retention mechanism includes a second sealing member 631 extending from the outer surface 648 of the base 628. In the embodiment shown, the sealing members 630, 631 are V-seals; other configurations are also possible. A vacuum inlet 662 is defined in the outer surface 648 between the sealing members 630, 631. The vacuum inlet 662 is in communication with a vacuum passage 656 terminating in a vacuum outlet 658, the vacuum outlet 658 engageable to a vacuum source 660 (e.g. pump) to pull air through the vacuum passage 656. The vacuum defined between the two sealing members 630, 631 retains the outer surface 648 of the base 628 against the inner surface 511 of the plate component 508. Alternately, mechanical retaining mechanisms may be used, e.g. clamps.

The drain passage 670 is defined through the body 616 and is angled, defining a flow direction toward the longitudinal axis L of the guide 618. The inlet 672 of the drain passage 670 communicates with the annular gap 552, and the outlet 676 of the drain passage 670 is defined below the guide 618. In the embodiment shown, the body 616 includes a cavity 678 under the guide 618 with which the outlet 676 of the drain passage 670 communicates, such that the drained fluid may be recuperated in the cavity 678. The cavity 678 includes a draining outlet 680 through which the fluid may be removed from the cavity 678, for example through aspiration.

In use, air flows through the air passage 544, between the outer surface 648 of the base 628 and the inner surface 511 of the plate component 508, into the annular gap 552 around the guide 618, into the drain passage 670, and to the cavity 678. The air flow “pulls” any fluid located in proximity of the annular gap 552 into the annular gap 552 and through the drain passage 670, away from the inner surface 511 of the plate component 508, and into the cavity 678.

It is understood that the elements of the sealing assemblies 510, 610 may be combined into a single assembly, for example with guides 518 such as shown in FIGS. 11-12 inserted into first holes 513a of the plate component 508 and guides 618 such as shown in FIG. 13 inserted into second holes 513b the plate component 508, with the second holes 513b larger than the first holes 513a. The plate component 508 may include additional pin-sized or fastener-sized holes which are plugged through any other appropriate matter, for example through the use of tape.

In a particular embodiment, the sealing assemblies 10, 510, 610, plug assemblies 14, 114, 314, 414, plugs 16, 116, 216, 316, 416, and/or bodies 516, 616 may provide several benefits. For example, the effectiveness of sealing may be increased with respect to passive silicon plugs engaged with the open ends of the stringers and/or into the holes of the bulkheads, and the risk of contamination of the component surface with the silicon, which may hinder the adhesion of a coating later applied to the stringer, may be avoided. The sealing assemblies 10, 510, 610, plug assemblies 14, 114, 314, 414, plugs 16, 116, 216, 316, 416, and/or bodies 516, 616 may provide for a faster installation, which translates into a shorter overall inspection time. Moreover, the sealing assemblies 10, 510, 610, plug assemblies 14, 114, 314, 414, plugs 16, 116, 216, 316, 416, and/or bodies 516, 616 may provide a smooth transition for the ultrasonic machine at the end of the stringers and around the holes of the bulkheads, allowing the probe(s) to inspect the entire outer surface of the components.

It is understood that although the sealing assemblies 10, 510, 610, plug assemblies 14, 114, 314, 414, plugs 16, 116, 216, 316, 416, and/or bodies 516, 616 are shown here as used in the inspection of stringers and bulkheads, it is understood that there use is not so limited and they can alternately be used in the inspection of other type of components, including other components of the aircraft and non-aircraft related components.

In use, and in a particular embodiment, the sealing assemblies 10, 510, 610, plug assemblies 14, 114, 314, 414, plugs 16, 116, 216, 316, 416, and/or bodies 516, 616 allow for the following method of wetting the outer surface of a component for inspection. The edge 150, 450, 550, 650 of the guide 18, 418, 518, 618 is juxtaposed to the edge 51, 551 of the component 8, 508, and the outer surface 19, 519 of the guide is aligned with the outer surface 9, 509 of the component. A flow of air is created along the inner surface 11, 511 of the component toward the edge of the component, across the gap 52, 552 between the edge of the component and the edge of the guide, and in the guide away from the inner surface of the component. The coupling fluid is flowed onto the outer surface 9, 509 of the component, and with the flow of air, the coupling fluid is directed from the outer surface 9, 509 of the component into the gap 52, 552 between the edge of the component and the edge of the guide and away from the inner surface of the component. Accordingly, interference from the presence of the coupling fluid on the inner surface 11, 511 of the component may be reduced or eliminated.

In the case of a tubular component such as a stringer 8 and skin 7 assembly, the edges are juxtaposed by juxtaposing the open ends of the guide and component. The plug is inserted partially into the tubular component and partially into the guide, and the plug is sealingly engaged with the inner surface of the component. The air flows out of the plug from inside the component toward the guide, between an outer surface of the flow-directing body of the plug and the inner surface of the component, across the gap between the edge of the component and the edge of the guide, and between the outer surface of the flow-directing body and an inner surface of the guide. In a particular embodiment, a venturi is created between the outer surface of the flow-directing body and the inner surfaces of the component and the guide in proximity of the gap between the juxtaposed ends of the guide and component, to help direct the flow of coupling fluid into the guide and away from the inner surface of the component.

In the case of a plate component such as a bulkhead, the guide is inserted into the hole of the component, and the edge along the perimeter of a hole through the component is juxtaposed to the edge defined along a perimeter of the guide. The outer surface of the base is sealingly engaged with the inner surface of the component away from the guide. The air flows between the outer surface of the base and the inner surface of the component toward the guide, across the gap between the edges of the component and of the guide, and in a drain passage extending away from the inner surface of the component. In a particular embodiment, an additional flow of air is created in the drain passage from a location offset from the gap between the edges of the component and of the guide, such that the flow of air and additional flow of air flow along the same direction.

In a particular embodiment, the guide and component are made of different materials such as to facilitate the distinction between the guide and component when interpreting the results of the inspection. However, since the gap between the juxtaposed edges of the guide and component is typically detectable during inspection, it is also possible to use a guide made of the same material as the component.

It is understood that any combination or sub-combination of the elements of the different embodiments is within the scope of this disclosure. While the methods and systems described herein have been described and shown with reference to particular steps performed in a particular order, it will be understood that these steps may be combined, subdivided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A plug assembly for inserting into an end of a tubular component to be inspected, the plug assembly comprising:
an air discharge unit having a longitudinal axis and at least one outer surface defining a perimeter around the longitudinal axis, the perimeter receivable within the tubular component, the air discharge unit having a plurality of outlets defined therein;
a flow-directing body extending from an end surface of the air discharge unit, the plurality of outlets being located radially outwardly of the flow-directing body, the flow-directing body including an inlet, the flow-directing body and air discharge unit having at least one passage defined therethrough extending from the inlet to the plurality of outlets;
a sealing member connected to the air discharge unit, the plurality of outlets located between the sealing member and the flow-directing body, the sealing member having an extended configuration where the sealing member extends outwardly of the perimeter of the at least one outer surface of the air discharge unit; and
a guide having outer surfaces complementary to that of the tubular component to be inspected such as to define an extension of the tubular component when engaged thereto, the flow-directing body partially received in the guide, the air discharge unit, sealing member and a portion of the flow-directing body extending outside of the guide.

2. The plug assembly as defined in claim 1, wherein a radial distance between a longitudinally extending outer surface of the flow-directing body and the longitudinal axis is at a maximum value at a first location spaced from the air discharge unit along the longitudinal axis and at a smaller value at a second location adjacent the air discharge unit, the radial distance increasing between the second and first locations.

3. The plug assembly as defined in claim 1, wherein a radial distance between each of at least two longitudinally extending outer surfaces of the flow-directing body and the longitudinal axis is at a maximum value at a first location spaced from the air discharge unit along the longitudinal axis and at a smaller value at a second location adjacent the air discharge unit, the radial distance increasing between the second and first locations, the first location of one of the at least two longitudinally extending outer surfaces being spaced along the longitudinal axis from the first location of another one of the at least two longitudinally extending outer surfaces.

4. The plug assembly as defined in claim 2, wherein the flow-directing body has a cross-sectional area having a maximum value at the first location.

5. The plug assembly as defined in claim 2, wherein the radial distance between the outer surface of the flow-directing body and the longitudinal axis decreases from the first location to a third location, the first location being defined between the second and third locations.

6. The plug assembly as defined in claim 5, wherein a space around the flow-directing body defines a venturi when the flow-directing body is received in a tube having a constant inner cross-section from the second to the third locations, said venturi being positioned in proximity of a gap formable between edges of the guide and the tubular component.

7. The plug assembly as defined in claim 1, wherein the sealing member is inflatable and has the extended configuration when inflated, the flow-directing body and air discharge unit having an additional passage defined therethrough extending from an additional inlet of the flow-directing body to an interior of the sealing member.

8. The plug assembly as defined in claim 1, wherein the sealing member is inflatable and has the extended configuration when inflated, the at least one passage of the guide body and air discharge unit communicating with an interior of the sealing member.

9. The plug assembly as defined in claim 1, wherein the flow-directing body has a vacuum chamber defined therein, a vacuum chamber outlet in communication with the vacuum chamber, and at least one vacuum chamber inlet in communication with the vacuum chamber, the at least one vacuum chamber inlet located adjacent an outer surface of the flow-directing body and facing the plurality of outlets of the air discharge unit to receive a flow exiting from the plurality of outlets and traveling along the outer surface of the flow-directing body.

10. The plug assembly as defined in claim 1, wherein the perimeter of the air discharge unit has a triangular or trapezoidal shape.

11. (canceled)

12. A sealing assembly comprising:
a plurality of plug assemblies each as defined in claim 1;
a base, each guide detachably engageable to the base with the plurality of plug assemblies spaced apart from one another, each plug protruding from the base;
a manifold in communication with the inlet of each plug; and
a source of pressurized air in communication with the manifold.

13. A plug assembly for engaging an end of a tubular component to be inspected, the assembly comprising:
a guide having interconnected walls defining outer surfaces complementary to that of the tubular component to be inspected such as to define an extension of the tubular component when a first end of the guide is adjacent thereto, at least one of the interconnected walls having a plurality of openings defined therethrough;
a flow-directing body having a longitudinal axis, the flow-directing body having a first end received in the guide and sealingly engaged to the interconnected walls with the plurality of openings located between the first end of the flow-directing body and the first end of the guide, the flow-directing body extending out of the first end of the guide, the flow-directing body having an outer surface extending a radial distance from the longitudinal axis, the radial distance increasing from a location proximal the plurality of openings to a location proximal the first end of the guide, the radial distance decreasing from the location proximal the first end of the guide to a location proximal a second end of the flow-directing body.

14. The plug assembly as defined in claim 13, further comprising fins extending outwardly from the outer surface of the flow-directing body in a portion of the flow-directing body located outside of the guide, the fins being receivable in a perimeter corresponding to that defined by the inner surfaces of the interconnected walls of the guide.

15.-30. (canceled)
